(19) United States
(12) Patent Application Publication
(10) Pub. No.: US 2018/0141833 A1
(43) Pub. Date: May 24, 2018

(54) ELECTROLYZED WATER GENERATOR

(71) Applicant: SHARP KABUSHIKI KAISHA, Sakai City, Osaka (JP)

(72) Inventors: NOBUTOSHI ARAI, Kobe City (JP); NOBUHIRO HAYASHI, Kobe City (JP)

(21) Appl. No.: 15/570,289

(22) PCT Filed: Aug. 21, 2015
(86) PCT No.: PCT/JP2015/073565

§ 371 Date: Oct. 27, 2017

(30) Foreign Application Priority Data
Apr. 28, 2015 (JP) 2015-091741

(51) Int. Cl. C02F 1/467; C02F 1/461

(52) U.S. Cl. CPC C02F 1/4674; C02F 1/46104; C02F 2001/46133; C02F 2201/4611; C02F 1/46109

(57) ABSTRACT

The present invention provides an electrolyzed water producing apparatus capable of efficiently producing electrolyzed water containing hypochlorous acids and of being installed stably. An electrolyzed water producing apparatus of the present invention includes: an electrolyzing section, the electrolyzing section including (i) an electrode pair having a positive electrode and a negative electrode facing the positive electrode and (ii) a no-diaphragm-type electrolytic solution channel between the positive electrode and the negative electrode, the electrode pair being inclined in such a manner that the positive electrode is positioned higher than the negative electrode, the electrolytic solution channel allowing an electrolytic solution to flow into the electrolytic solution channel from below and allowing electrolyzed water, which has been produced by electrolyzing the electrolytic solution with use of the electrode pair and which contains hypochlorous acids, to flow out from an upper portion of the electrolytic solution channel, the electrode pair being inclined at an angle of not less than 10 degrees and not more than 85 degrees relative to a vertical direction.

### TECHNICAL FIELD

The present invention relates to an electrolyzed water producing apparatus.

### BACKGROUND ART

Hypochlorous acids such as a hypochlorous acid and sodium hypochlorite are used as, for example, a bleaching agent or disinfectant for clean-water and sewage treatment, waste water treatment, and household kitchen, laundry, and the like. Hypochlorites are produced by (i) a method of reacting, with chlorine gas, an alkali hydroxide produced through electrolysis of an aqueous solution of an alkali metal chloride such as a saline solution or (ii) a method of electrolyzing an aqueous solution of an alkali metal chloride in a no-diaphragm electrolytic bath for production of an aqueous hypochlorite solution in the electrolytic bath.

The method for producing hypochlorous acids through electrolysis of an aqueous solution of an alkali metal chloride is presumed to involve proceeding of an anodic reaction such as those represented in Reaction Formulae (1) and (3) and proceeding of a cathodic reaction such as that represented in Reaction Formula (4). The method is also presumed to involve proceeding of a reaction between Cl₂ generated as a result of an anodic reaction and water as represented in Reaction Formula (2).

2Cl−−>Cl₂+2e− (1)

Cl₂+H₂O−>HCl+HClO (2)

H₂O −>1/2O₂+2H⁺+2e⁻ (3)

2H₂O+2e⁻−>H₂+2OH⁻ (4)

In a case where the aqueous solution has become strongly acidic (with a pH of not more than 3), the velocity of the reaction represented in Reaction Formula (2) is decreased, and a reverse reaction may generate chlorine gas.

Further, there has been known a method for producing electrolyzed water containing hypochlorous acids (see, for example, Patent Literatures 1 to 6).

### CITATION LIST

### Patent Literature

[Patent Literature 1]

Japanese Patent Application Publication, Tokukaihei, No. 4-74879

[Patent Literature 2]

Japanese Patent Application Publication, Tokukaihei, No. 5-237478

[Patent Literature 3]

Japanese Patent Application Publication, Tokukaihei, No. 6-292892

[Patent Literature 4]

Japanese Patent Application Publication, Tokukaihei, No. 9-253650

[Patent Literature 5]

Japanese Patent Application Publication, Tokukai, No. 2001-29955

[Patent Literature 6]

Japanese Patent Application Publication, Tokukai, No. 2001-48199

### SUMMARY OF INVENTION

### Technical Problem

Conventional methods for producing electrolyzed water involve a positive electrode and a negative electrode both placed vertically to prevent chlorine gas, hydrogen gas, and/or the like from remaining between the positive electrode and the negative electrode. Placing a positive electrode and a negative electrode vertically may, however, result in a large-sized electrolyzed water producing apparatus or a tall electrolyzed water producing apparatus that topples over easily.

The present invention has been accomplished in view of the above issue, and provides an electrolyzed water producing apparatus capable of efficiently producing electrolyzed water containing hypochlorous acids and of being installed stably.

### Solution to Problem

The present invention provides an electrolyzed water producing apparatus including an electrolyzing section, the electrolyzing section including (i) an electrode pair having a positive electrode and a negative electrode facing the positive electrode and (ii) a no-diaphragm-type electrolytic solution channel between the positive electrode and the negative electrode, the electrode pair being inclined in such a manner that the positive electrode is positioned higher than the negative electrode, the electrolytic solution channel allowing an electrolytic solution to flow into the electrolytic solution channel from below and allowing electrolyzed water, which has been produced by electrolyzing the electrolytic solution with use of the electrode pair and which contains hypochlorous acids, to flow out from an upper portion of the electrolytic solution channel, the electrode pair being inclined at an angle of not less than 10 degrees and not more than 85 degrees relative to a vertical direction.

### Advantageous Effects of Invention

An electrolyzed water producing apparatus of the present invention includes an electrolyzing section, the electrolyzing section including (i) an electrode pair having a positive electrode and a negative electrode facing the positive electrode and (ii) a no-diaphragm-type electrolytic solution channel between the positive electrode and the negative electrode. Applying a voltage to the electrode pair can electrolyze an electrolytic solution flowing through the electrolytic solution channel and can thereby produce electrolyzed water containing hypochlorous acids.

The electrode pair included in the electrolyzing section is inclined in such a manner that the positive electrode is positioned higher than the negative electrode. The electrolytic solution channel allows an electrolytic solution to flow into the electrolytic solution channel from below and allows electrolyzed water, which has been produced by electrolyzing the electrolytic solution with use of the electrode pair and which contains hypochlorous acids, to flow out from an upper portion of the electrolytic solution channel. This makes it possible to efficiently produce electrolyzed water containing hypochlorous acids. This has been substantiated by experiments conducted by the inventors of the present invention.

The present invention makes it possible to efficiently produce electrolyzed water containing hypochlorous acids presumably for the following reason: An electrolyzed water producing apparatus of the present invention is configured such that a cathodic reaction at the negative electrode positioned lower generates hydrogen gas in the form of bubbles on the negative electrode and that those bubbles rise across the flow of a fluid toward the positive electrode positioned higher. The flow of a fluid which flow is caused by the rising bubbles causes a fluid in the vicinity of the negative electrode and a fluid in the vicinity of the positive electrode to be stirred and mixed with each other, thereby accelerating an anodic reaction at the positive electrode. This makes it possible to efficiently produce electrolyzed water containing hypochlorous acids. Disposing the negative electrode below to cause a flow from the negative electrode to the positive electrode can prevent the electrode surface of the negative electrode from being oxidized by, for example, chlorine gas, an oxidizing substance, and/or a hypochlorous acid through an anodic reaction, presumably making it possible to efficiently produce electrolyzed water containing hypochlorous acids. Further, since oxidation of the electrode surface of the negative electrode is prevented, the negative electrode may be a Ti electrode. This helps reduce the cost of producing the electrolyzed water producing apparatus.

The electrode pair included in the electrolyzing section is inclined at an angle of not less than 10 degrees and not more than 85 degrees relative to a vertical direction. This makes it possible to efficiently produce electrolyzed water containing hypochlorous acids. This has been substantiated by experiments conducted by the inventors of the present invention. Inclining the electrode pair sufficiently as above makes it possible to produce an electrolyzed water producing apparatus that has a small height and that can be installed stably. With the above configuration, the electrolyzed water producing apparatus has a reduced risk of toppling over, for example.

### BRIEF DESCRIPTION OF DRAWINGS

FIG. 1 is a schematic cross-sectional view of an electrolyzed water producing apparatus of an embodiment of the present invention. (Embodiment 1)
(a) to (e) of FIG. 2 are each a schematic cross-sectional view of part of an electrolyzed water producing apparatus of an embodiment of the present invention. (Embodiments 2 to 6)

FIG. 3 is a schematic cross-sectional view of part of an electrolyzed water producing apparatus of an embodiment of the present invention. (Embodiment 7)

FIG. 4 is a graph illustrating the measurement results of an experiment of measuring an effective chlorine concentration.

FIG. 5 is a graph illustrating the measurement results of an experiment of detecting electrolyzed water.

FIG. 6 is a graph illustrating the measurement results of an experiment of detecting electrolyzed water.

### DESCRIPTION OF EMBODIMENTS

An electrolyzed water producing apparatus of the present invention includes: an electrolyzing section, the electrolyzing section including (i) an electrode pair having a positive electrode and a negative electrode facing the positive electrode and (ii) a no-diaphragm-type electrolytic solution channel between the positive electrode and the negative electrode, the electrode pair being inclined in such a manner that the positive electrode is positioned higher than the negative electrode, the electrolytic solution channel allowing an electrolytic solution to flow into the electrolytic solution channel from below and allowing electrolyzed water, which has been produced by electrolyzing the electrolytic solution with use of the electrode pair and which contains a hypochlorous acid, to flow out from an upper portion of the electrolytic solution channel, the electrode pair being inclined at an angle of not less than 10 degrees and not more than 85 degrees relative to a vertical direction.

The electrode pair included in the electrolyzed water producing apparatus of the present invention may preferably be inclined at an angle of not less than 50 degrees and not more than 80 degrees relative to the vertical direction.

This makes it possible to efficiently produce electrolyzed water containing hypochlorous acids. Inclining the electrode pair sufficiently as above makes it possible to produce an electrolyzed water producing apparatus that has a small height and that can be installed stably. With the above configuration, the electrolyzed water producing apparatus has a reduced risk of toppling over, for example.

The positive electrode and the negative electrode both included in the electrolyzed water producing apparatus of the present invention may preferably each have a substantially rectangular electrode surface and be each oriented in such a manner that a first lengthwise end of the electrode surface is positioned higher than a second lengthwise end of the electrode surface.

This configuration provides a long electrolytic solution channel, thereby increasing the electrolysis efficiency.

The electrode pair included in the electrolyzed water producing apparatus of the present invention may preferably be configured such that a ratio of (i) a distance between the positive electrode and the negative electrode to (ii) a length of the electrode surface is within a range of 1:100 to 1:10.

This configuration allows bubbles generated by a cathodic reaction to rise to be close to the positive electrode, thereby increasing the electrolysis efficiency.

The negative electrode included in the electrolyzed water producing apparatus of the present invention may preferably be a Ti electrode.

A Ti electrode can be produced relatively inexpensively. This helps reduce the cost of producing the electrolyzed water producing apparatus. Further, the negative electrode being positioned lower in the electrode pair can prevent the negative electrode (Ti electrode) from occluding hydrogen gas generated at the negative electrode and being warped in consequence.

The electrolytic solution, which is a material of electrolyzed water, may preferably include an aqueous solution containing an acidic substance and an alkali metal chloride.

This makes it possible to produce electrolyzed water containing hypochlorous acids. The above configuration also makes it possible to produce slightly acidic to neutral electrolyzed water having a great bacteria elimination property.

The electrolyzed water producing apparatus of the present invention may preferably further include: a diluting section configured to dilute the electrolyzed water, which is produced by the electrolyzing section.

Including the diluting section to dilute electrolyzed water produced by the electrolyzing section makes it possible to increase the amount of electrolyzed water produced as a final product. The above configuration also makes it possible to reduce consumption of an electrolytic solution as a material of electrolyzed water.

The electrolyzed water producing apparatus of the present invention may preferably further include a cooling section configured to cool the electrode pair, and the cooling section may preferably cool the electrode pair with use of water intended for dilution of the electrolyzed water.

This configuration makes it possible to prevent the temperature of the electrode pair from being increased by heat of an electrolysis reaction, thereby making it possible to prevent the electrolysis efficiency from being decreased.

The electrolyzed water producing apparatus of the present invention may preferably further include: an electrolytic solution supplying section; and a detecting section, and the detecting section may preferably be configured to detect a decrease in an amount of the electrolytic solution which amount is supplied from the electrolytic solution supplying section to the electrolytic solution channel. The electrolytic solution supplying section may be disposed in such a manner as to supply an electrolytic solution in the tank to the electrolytic solution channel.

In a case where a decrease in the supply of an electrolytic solution has decreased the amount of the electrolytic solution in the electrolyzing section, that may result in a decrease in the effective area of an electrode, that is, the area of an electrode substantially in contact with the electrolytic solution and contributing to electrolysis. In a case where, in particular, an electrode pair for electrolysis is inclined to a degree beyond the conventional technical knowledge as in the present invention, a change in the amount of an electrolytic solution leads to a larger proportion of change in the effective area of an electrode.

In such a case, it is desirable to include a detector capable of detecting an abnormality earlier than conventional electrolyzed water producing apparatuses.

The detecting section may preferably include a detection electrode for measuring an electrical property of the electrolytic substance (electrolytic solution), the electrolysis product (electrolyzed water), or a mixture of the electrolytic solution and the electrolyzed water and be configured to detect (i) a decrease in an amount of the electrolytic substance (electrolytic solution) which amount is supplied to the electrolyzing section or (ii) a decrease in an amount of the electrolysis product (electrolyzed water) which amount is discharged from the electrolyzing section.

The present specification may use the term “electrolytic solution” to mean any electrolytic substance and/or the term “electrolyzed water” to mean any electrolysis product.

The detection electrode may be disposed above the electrolysis electrode.

The detection electrode may be disposed upstream of the electrolysis electrode.

The detection electrode may be disposed at a position downstream of the electrolysis electrode which position is in the electrolyzing section or in a pipe connected to the electrolyzing section.

The detection electrode may include at least one pair of electrodes, one of the electrodes being electrically connected to the electrolysis electrode.

The detection electrode may include at least one pair of electrodes, one of the electrodes being integrated with the electrolysis electrode.

The detection electrode may preferably be inclined.

The detection electrode may preferably be disposed in such a manner as to measure an electrical property of a fluid of a mixture of gas and electrolyzed water which fluid has been generated through electrolysis of the electrolytic solution.

The detecting section may preferably be configured to, on a basis of an amount of change over time in a relationship between a current flowing through the electrode pair and a voltage applied to the detection electrode, detect a decrease in an amount of the electrolytic substance which amount is supplied to the electrolyzing section.

The detecting section may be configured to detect, on the basis of a derivative value of the amount of change in the voltage applied to the detection electrode or a derivative value of the amount of change in the current flowing through the detection electrode, detect a decrease in an amount of the electrolytic substance which amount is supplied to the electrolyzing section.

The detecting section may be configured to, on the basis of the amount of change over time in the relationship between the current flowing through the electrode pair and the voltage applied to the electrolysis electrode, detect a decrease in an amount of the electrolytic substance (electrolytic solution) which amount is supplied to the electrolyzing section.

The detecting section may be configured to detect, on the basis of a derivative value of the amount of change in the voltage applied to the electrolysis electrode or a derivative value of the amount of change in the current flowing through the electrolysis electrode, detect a decrease in an amount of the electrolytic substance which amount is supplied to the electrolyzing section. This detecting section allows an electrode to be used for both the electrolysis and the detection.

The above configuration allows the detecting section to detect a decrease in an amount of the electrolytic substance which amount is supplied to the electrolyzing section. This in turn makes it possible to stop the application of a voltage to the electrode pair early. The above configuration thus makes it possible to prevent abnormal heat generation in the members of the electrolyzing section such as the electrolysis electrode and improve the safety of the electrolyzing device. The above configuration further makes it possible to reduce damage to the members of the electrolyzing section such as the electrolysis electrode and extend the life of the electrolyzing device.

This makes it possible to use the detection electrode to detect whether the electrolyzing section is producing electrolyzed water normally.

The following description will discuss an embodiment of the present invention with reference to the drawings. The configurations illustrated in the drawings or described below are mere examples. The present invention is not limited in scope to the configurations illustrated in the drawings or described below.

The electrolyzed water producing apparatus of the present embodiment may cover, in its concept, the electrolyzed water producing apparatus each of Embodiments 1 to 7. FIG. 1 is a schematic cross-sectional view of an electrolyzed water producing apparatus of Embodiment 1.

The electrolyzed water producing apparatus 25 of the present embodiment includes an electrolyzing section 5, the electrolyzing section 5 including (i) an electrode pair 1 having a positive electrode 3 and a negative electrode 4 facing the positive electrode 3 and (ii) a no-diaphragm-type electrolytic solution channel 7 between the positive electrode 3 and the negative electrode 4, the electrode pair 1 being inclined in such a manner that the positive electrode 3 is positioned higher than the negative electrode 4, the electrolytic solution channel 7 allowing an electrolytic solution 12 to flow into the electrolytic solution channel 7 from below and allowing electrolyzed water, which has been produced by electrolyzing the electrolytic solution 12 with use of the electrode pair 1 and which contains hypochlorous acids, to flow out from an upper portion of the electrolytic solution channel 7, the electrode pair 1 being inclined at an angle of not less than 10 degrees and not more than 85 degrees relative to the vertical direction.

The electrolyzed water producing apparatus 25 of the present embodiment may further include (i) a diluting section 18 configured to dilute electrolyzed water produced by the electrolyzing section 5, (ii) a cooling section 34 configured to cool the electrode pair 1, (iii) an electrolytic solution supplying section 13, (iv) a detecting section 27, and/or (v) a stirring section 19.

For a better understanding, FIG. 1 illustrates main components of the producing apparatus in such a manner that they do not overlap with each other in the depth direction. However, using an electrolyzing section 5 having a discharge opening at a position on an extension of the direction of the channel between the electrodes allows the electrolyzing section 5 to be positioned at a height substantially equal to the respective heights at which are positioned a valve 16 (through which dilution water flows), a channel 26, the diluting section 18, a channel 24, the stirring section 19, and a discharge opening 29. Using an electrolyzing section 5 further having a supply opening at a position on an extension of the direction of the channel between the electrodes allows the lowermost portion of the electrolyzing section 5 to be positioned at a height substantially equal to the respective heights at which are positioned a supply channel 23, an electrolytic solution supplying section 13 (pump 15), and the bottom surface of the tank 11. Using an external tank as the tank 11 allows the producing apparatus 25 to be compact, and provides the flexibility to select, for example, a large-capacity or small-capacity tank depending on how the producing apparatus 25 is used.

This configuration allows the internal height of the producing apparatus to be substantially as small as the height of the electrolyzing section 5. Further, orienting an electrolyzing section of the present invention at an angle of degrees makes it possible to produce a producing apparatus having a conventionally unattainable height.

The following description will discuss the electrolyzed water producing apparatus 25 of the present embodiment.

The electrolytic solution supplying section 13 may be disposed in such a manner as to supply an electrolytic solution 12 in the tank 11 to the electrolytic solution channel 7 with use of the pump 15. The tank 11 may be built in the electrolyzed water producing apparatus 25 or be external to the electrolyzed water producing apparatus 25. In a case where the tank 11 is external to the electrolyzed water producing apparatus 25, the electrolyzed water producing apparatus 25 may have an electrolytic solution inlet. This configuration allows the external tank 11 to be connected to the electrolytic solution inlet with use of a pipe. The electrolytic solution supplying section 13 may include at least one of a large-capacity tank 11 and a tank 11 having a normal capacity. This configuration makes it possible to use a tank 11 having a capacity intended for the use of the electrolyzed water producing apparatus 25.

In a case where the tank 11 is disposed at a position higher than the position of the electrolyzing section 5 so that the electrolytic solution 12 may be supplied to the electrolyzing section 5 by gravitation, the pump 15 may be replaced with a valve.

The electrolytic solution 12, which the electrolytic solution supplying section 13 supplies to the electrolytic solution channel 7, may be an aqueous solution containing an acidic substance and an alkali metal chloride. The electrolytic solution 12 may alternatively be an aqueous solution containing (i) hydrochloric acid, acetic acid, or citric acid and (ii) at least one of sodium chloride and potassium chloride. This configuration allows the electrolyzing section 5 to produce electrolyzed water containing hypochlorous acid (HClO), a hypochlorite (such as NaClO and KClO), and an alkali metal chloride.

The electrolyzing section 5 includes an electrode pair 1 having a positive electrode 3 and a negative electrode 4 facing the positive electrode 3. The positive electrode 3 and the negative electrode 4 may each be in the shape of a plate. The positive electrode 3 has an electrode surface 8, whereas the negative electrode 4 has an electrode surface 9. The positive electrode 3 and the negative electrode 4 are disposed in such a manner that the electrode surface 8 and the electrode surface 9 face each other with no diaphragm in-between. The electrode surface 8 of the positive electrode 3 and the electrode surface 9 of the negative electrode 4 define an electrolytic solution channel 7 therebetween. Disposing the positive electrode 3 and the negative electrode as above achieves a short distance therebetween and thereby increases the electrolysis efficiency. The positive electrode 3 and the negative electrode 4 may be disposed in such a manner as to be (i) substantially parallel to each other and (ii) separated from each other by a distance within a range of 1 mm to 10 mm. The electrode surface 8 of the positive electrode 3 and the electrode surface 9 of the negative electrode 4 may be planar electrode surfaces facing each other or curved electrode surfaces facing each other.

The electrode pair 1 may be configured such that (i) a single plate-shaped positive electrode 3 and a single plate-shaped negative electrode 4 face each other, that (ii) positive electrodes 3 and negative electrodes 4 are disposed alternately with gaps therebetween, or that (iii) a plurality of electrodes are disposed on top of each other with each intermediate electrode having one surface serving as a positive electrode 3 and the other surface serving as a negative electrode 4.

The electrode pair 1 includes, for example, (i) an electrode (herein referred to as Ti electrode) made of a titanium plate and (ii) an electrode (herein referred to as Pt—Ir-coated Ti electrode) prepared by coating a titanium plate with platinum and iridium through a sintering process. The electrode pair 1 may be connected to a power source section in such a manner that a Ti electrode serves as a negative electrode 4 and that a Pt—Ir-coated Ti electrode serves as a positive electrode 3.

As in the electrolyzed water producing apparatus 25 illustrated in FIG. 1, the electrode pair 1 may be disposed in such a manner that the supply channel 23 for the electrolytic solution 12 is connected to the electrolytic solution channel 7, and the electrolytic solution channel 7 is connected to the electrolyzed water channel 24. The electrolyzing section 5 may have (i) an inlet through which the electrolytic solution supplying section 13 supplies the electrolytic solution 12 to the electrolytic solution channel 7 and (ii) an outlet through which electrolyzed water flows out from the electrolytic solution channel 7. This configuration allows the electrolyzing section 5 to produce electrolyzed water continuously. The electrolyzed water that has flown out from the outlet may be introduced into the diluting section 18.

The electrode pair 1 may be immersed into an electrolytic solution 12 in an electrolytic bath or dilution bath. In this case, electrolysis by the electrode pair 1 generates bubbles, which rise and cause a flow of electrolytic solution 12 as an electrolytic solution channel 7.

The electrolyzing section 5 carries out an electrolytic treatment in which presumably, an anodic reaction such as those represented in, for example, Reaction Formulae (1) and (3) above proceeds, whereas a cathodic reaction such as that represented in, for example, Reaction Formula (4) above proceeds, and in which presumably, a reaction such as that represented in Reaction Formula (2) above proceeds in, for example, the electrolyzing section 5, the diluting section 18, the electrolyzed water channel 24, and/or the stirring section 19. The electrolyzing section 5 thus produces electrolyzed water in the form of a fluid of a mixture of gas and liquid, the fluid including electrolyzed water and bubbles of, for example, chlorine gas and hydrogen gas mixed in the electrolyzed water. As a reaction such as that represented in Reaction Formula (2) proceeds, the number of bubbles decreases, and the concentration of hypochlorous acids in the electrolyzed water increases. Since the reaction of Reaction Formula (2) proceeds relatively rapidly, many of the chlorine molecules generated react in the electrolyzing section 5 to be hypochlorous acids. Unreacted chlorine molecules are subjected to a large amount of water (H₂O) in the diluting section 20. Bubbles of chlorine gas disappear almost entirely during a flow through the electrolyzed water channel.

Electrolyzing an aqueous solution containing an alkali metal chloride may generate a hypochlorite such as sodium hypochlorite and potassium hypochlorite and make the electrolyzed water alkaline. However, since the electrolytic solution 12 of the present embodiment contains an acidic substance, the electrolyzed water is substantially neutral.

The electrolyzed water producing apparatus 25 can produce electrolyzed water having a pH of, for example, 6.5 to 7.5. The ratio between an alkali metal chloride and acidic substance for the electrolytic solution 12 may be adjusted for production of electrolyzed water having a pH of 6.5 to 7.5.

Further, in a case where the pH is to be lower, the pH of the electrolyzed water may be adjusted by adjusting, for example, (i) the proportion of the acidic substance in the electrolytic solution, (ii) the amount of the electrolytic solution supplied to the electrolyzing section, (iii) the voltage applied to the electrolysis electrodes, and/or (iv) the amount of the electric current flowing through the electrolysis electrodes.

The electrode pair 1 is inclined in such a manner that the positive electrode 3 is positioned higher than the negative electrode 4. Further, the electrolytic solution channel 7, which is defined by the electrode surface 8 of the positive electrode 3 and the electrode surface 9 of the negative electrode 4, allows an electrolytic solution 12 to flow into the electrolytic solution channel 7 from below and allows electrolyzed water, which has been produced by electrolyzing the electrolytic solution 12 with use of the electrode pair 1 and which contains hypochlorous acids, to flow out from an upper portion of the electrolytic solution channel 7. With this configuration, a flow of a fluid which flow is caused by rising bubbles generated on the electrode surface 9 of the negative electrode 4 causes a fluid in the vicinity of the negative electrode 4 and a fluid in the vicinity of the positive electrode 3 to be stirred and mixed with each other, presumably accelerating an electrode reaction at the positive electrode 3. This in turn makes it possible to produce electrolyzed water containing effective chlorine at a high concentration.

Disposing the negative electrode 4 below to cause a flow from the negative electrode 4 to the positive electrode 3 can prevent the electrode surface 9 of the negative electrode 4 from being oxidized by, for example, chlorine gas, an oxidizing substance, and/or a hypochlorous acid through an anodic reaction, presumably making it possible to efficiently produce electrolyzed water containing hypochlorous acids. Further, since oxidation of the electrode surface 9 of the negative electrode 4 is prevented, the negative electrode 4 may be a Ti electrode. This helps reduce the cost of producing the electrolyzed water producing apparatus 25.

Disposing the negative electrode 4 below allows hydrogen gas generated by a cathodic reaction to be easily eliminated from the electrode surface 9 of the negative electrode 4. This prevents the effective area of the negative electrode from being decreased due to bubbles remaining on the electrode surface 9 of the negative electrode 4, thereby preventing the electrolysis efficiency from being decreased. Further, in a case where the negative electrode 4 is a Ti electrode, the above configuration can prevent the negative electrode 4 (Ti electrode) from occluding hydrogen molecules and being warped in consequence.

The electrode pair 1 is inclined at an angle of not less than 10 degrees and not more than 85 degrees relative to the vertical direction. The electrode pair 1 may preferably be inclined at an angle of not less than 50 degrees and not more than 80 degrees relative to the vertical direction. This makes it possible to efficiently produce electrolyzed water containing hypochlorous acids. This has been substantiated by experiments conducted by the inventors of the present invention. Inclining the electrode pair 1 sufficiently as above makes it possible to produce an electrolyzed water producing apparatus 25 that has a small height and that can be installed stably. With the above configuration, the electrolyzed water producing apparatus 25 has a reduced risk of toppling over, for example.

An electrolyzing section was prototyped that included, for example, a Pt—Ir-coated Ti electrode and a Ti electrode each having a size of 50 mm by 100 mm by 0.5 mm and separated from each other by a distance of 4 mm. The electrolyzing section had a total thickness of 16 mm and a total length of 140 mm, and was configured in such a manner as to be capable of being divided into two at a position near the center of the electrolyzing section to allow electrodes to be inserted. The electrolyzing section had a flange section having a flange at the center, the flange section having a thickness of 34 mm. The electrolyzing section was disposed at an angle of 80 degrees for preparation of an electrolyzed water producing apparatus. The flange section had the largest height, requiring a height of 36 mm. Without the flange section, the electrolyzed water producing apparatus can have a height of approximately 35 mm. The electrolyzing section was integrated with other members of an electrolyzed water producing apparatus, and the integrated product was placed in a resin housing having a thickness of 2 mm. This produced a producing apparatus that, although having a relatively large footprint, has an extremely small thickness of approximately 40 mm.

The positive electrode 3 may preferably have a substantially rectangular electrode surface 8 and be oriented in such a manner that one lengthwise end of the electrode surface 8 is positioned higher than the other lengthwise end. The negative electrode 4 may preferably have a substantially rectangular electrode surface 9 and be oriented in such a manner that one lengthwise end of the electrode surface 9 is positioned higher than the other lengthwise end. This configuration provides a long electrolytic solution channel 7, thereby increasing the electrolysis efficiency.

The electrode pair 1 may preferably be configured such that the ratio of (i) the distance between the positive electrode 3 and the negative electrode 4 to (ii) the length of the electrode surface 8 or 9 is within a range of 1:100 to 1:10. This configuration allows bubbles generated by a cathodic reaction to rise to be close to the positive electrode 3, thereby increasing the electrolysis efficiency.

The electrolyzed water producing apparatus 25 may include a detecting section 27 on the downstream side of the electrode pair 1. The detecting section 27 serves to detect a decrease in the amount of the electrolytic solution 12 supplied from the electrolytic solution supplying section to the electrolytic solution channel 7. The detecting section 27 may be disposed at a position higher than the position of the electrode pair 1.

The detecting section 27 may be in the form of (i) detection electrodes 28 for measuring electrical properties of electrolyzed water (such as the current, voltage, resistance, and/or capacitance) or (ii) a photodetector section configured to optically detect the state of electrolyzed water. The detecting section 27 may, however, preferably be a simple system. It may seem easy to use a method for measuring or optically detecting a capacitance because such a means will not come into contact with electrolyzed water and thus eliminate the need to consider how the means will be affected by electrolyzed water. However, using such a means will require a special component and/or control circuit as a separate member. In the case of detection electrodes, suitable conditions for the voltage, current, and the like vary depending on the target. Further, common knowledge of persons skilled in the art is that in a case where an electrolytic solution, which contains an electrolyte, is a target for the present invention, it will be difficult to detect the state of electrolyzed water with use of electrodes. Using electrodes as such has not been practiced as a result. Specifically, the electrolytic solution will be electrolyzed by a voltage or current for detection, which will in turn make it impossible to measure electrical properties of the electrolytic solution itself. Further, in a case where electrolysis produces a reactive liquid as electrolyzed water (for example, an oxidative liquid such as hypochlorous acid water and hypochlorite water), the electrodes themselves will presumably be oxidized and changed. In view of such observations, detection electrodes were regarded as lacking stability and/or a practical life. It was thus believed to be difficult to use an electrode(s) as an inexpensive, long-life detector to be mounted in a producing apparatus for a long-term, constant use. The inventors actually needed to select an appropriate position for the electrode(s) and an appropriate size for a channel at the electrode position, and thus had difficulty arriving at the present invention. For instance, in order to dispose an electrode(s) on the channel, the inventors secured a detection area in which the channel had a relatively large cross-sectional area. This configuration, however, caused the gas and the liquid to be separated from each other and failed to form a liquid membrane, with the result that it was impossible to detect a liquid (that is, a liquid membrane between bubbles) effectively. When the inventors reduced the channel diameter to a relatively small length to prevent the liquid membrane from being cut off or disposed the electrodes with a relatively small distance therebetween, surface tension kept a liquid membrane between the electrodes, with the result that no bubbles were detected. In either case, no clear current peak was detected, and it was impossible to distinguish between the steady state and an abnormal state early.

In a case where an electrolytic solution 12 in the tank 11 is supplied to the electrolyzing section 5 with use of the pump 15 for production of electrolyzed water, continuing the production gradually decreases the electrolytic solution 12 in the tank 11 and finally empties the tank 11. The emptied tank 11 stops the supply of the electrolytic solution 12 to the electrolyzing section 5, with the possible result that the electrolytic solution 12 between the electrode pair 1 is decreased or disappears. The electrolytic solution 12 between the electrode pair 1 may be decreased or disappear not only in the case where the tank 11 has been emptied, but also in a case where the pump 15 has broken down or there is liquid leakage between the tank 11 and the electrolyzing section 5, so that the electrolytic solution 12 is not supplied to the electrolyzing section 5 sufficiently. Applying a voltage to the electrode pair 1 in such a state leads to (i) an increase in heat in the electrolyzing section 5 as a result of a lack of a cooling effect by a continuously supplied electrolytic solution and a lack of heat dissipated together with produced electrolyzed water and/or (ii) in the case of a constant current, an increase in electric current density as a result of an electric current flowing through only a part of the electrodes, possibly damaging the electrode pair 1. This indicates the need to detect whether the supply of the electrolytic solution 12 between the electrode pair 1 is insufficient and stop applying a voltage to the electrode pair 1 as necessary.

Including the detecting section 27 makes it possible to detect whether the tank 11 has been emptied, the pump 15 is malfunctioning, and/or there is leakage or clogging in the pipe between the tank and the electrolyzing section. This in turn makes it possible to stop the application of a voltage to the electrode pair 1 early. The above configuration thus prevents the electrode pair 1 from being damaged.

In a case where the supply of the electrolytic solution 12 to the electrolyzing section 5 has become insufficient, the electrolytic solution 12 or electrolyzed water starts to disappear first from a high portion of the channel. Thus, disposing the detecting section 27 at a position higher than the position of the electrode pair 1 makes it possible to detect early whether the supply of the electrolytic solution 12 to the electrolyzing section 5 has become insufficient.
(a) of FIG. 2 is a schematic cross-sectional view of part of an electrolyzed water producing apparatus 25 of Embodiment 2. (b) of FIG. 2 is a schematic cross-sectional view of part of an electrolyzed water producing apparatus 25 of Embodiment 3. (c) of FIG. 2 is a schematic cross-sectional view of part of an electrolyzed water producing apparatus 25 of Embodiment 4. (d) of FIG. 2 is a schematic cross-sectional view of part of an electrolyzed water producing apparatus 25 of Embodiment 5. (e) of FIG. 2 is a schematic cross-sectional view of part of an electrolyzed water producing apparatus 25 of Embodiment 6. The detection electrodes 28 may be, for example, (i) an electrode pair disposed on a pipe between the electrolyzing section 5 and the diluting section 18 as in Embodiment 2 illustrated in (a) of FIG. 2, (ii) an electrode pair disposed in the channel inside the electrolyzing section 5 as in Embodiment 3 illustrated in (b) of FIG. 2, or (iii) an electrode pair disposed above the electrode pair 1 as in Embodiment 4 illustrated in (c) of FIG. 2. The detecting section 27 may be configured such that one of the electrode pair 1 and a detection electrode 28 are used to measure electrical properties of electrolyzed water as in Embodiment 5 illustrated in (d) of FIG. 2. The detecting section 27 may be configured such that one of the electrode pair 1 and a detection electrode 28 are used to measure electrical properties of electrolyzed water as in Embodiment 6 illustrated in (e) of FIG. 2.

Electrolyzing the electrolytic solution 12 with use of the electrode pair 1 involves chemical reactions such as those represented in Reaction Formulae (1) to (4) above. Electrolyzed water produced with use of the electrode pair 1 is thus a fluid of a mixture of gas and liquid. In a case where the detection electrodes 28 are used to measure electrical properties of a fluid of a mixture of gas and liquid, bubbles passing by the detection electrodes 28 increase the electric resistance between the electrodes and thus increase the current flowing between the electrodes, whereas a liquid passing by the detection electrodes 28 decreases the electric resistance between the electrodes and thus decreases the current flowing between the electrodes. This indicates that in a case where electrolyzed water is being produced normally with use of the electrode pair 1, properties measured with use of the detection electrodes 28 such as the electric resistance fluctuate. Detecting such a fluctuation thus makes it possible to learn that electrolyzed water is being produced normally. Further, detecting a lack of such a fluctuation makes it possible to detect an abnormality such as an empty tank, a broken liquid-flowing pump, a clogged pipe, and liquid leakage.

The detection electrodes 28 may be separated from each other by a distance of, for example, 1 mm to 5 mm. This configuration makes it possible to confirm the flow of electrolyzed water.

The example described here involves use of detection electrodes 28 to detect a flow of electrolyzed water. The detecting section 27 may alternatively be a photodetector section configured to optically detect a flow of electrolyzed water.

The detecting section has not only a tolerance (set value) for the voltage or current of the electrolysis electrodes, but also a tolerance for the amount of change over time in the voltage, current, or both of the electrolysis electrodes. The detecting section is capable of detecting an abnormality on the basis of a derivative value (which refers to the average change amount per unit of time) of the voltage value or current value of the electrolysis electrodes. The detecting section is, in this case, included in a control section. For other detection systems as well, including a detecting section in a control section is preferable because such a configuration can incorporate both sections in a single plated circuit and thereby achieve a smaller size and a lower cost.

For instance, electrodes for sensing are connected to a constant-current source or constant-voltage source, and are used to detect an abnormality by distinguishing the amount of change in the voltage value or current value between a normal state and an abnormal state within a certain period of time. A tolerance is set for the amount of change over time of the voltage, the current, or both. In other words, the detection electrodes are used to detect a derivative value of the voltage value or current value (the derivative value refers to the average change amount per unit of time and may also be expressed as a slope). The voltage value and the current value may be detected by a conventional method. A derivative value may be found by sampling the voltage value or current value at a fixed time interval(s) and calculating the voltage change over time. Sampling the voltage value or current value at an excessively short time interval will, however, lead to a false positive in abnormality detection as a result of noise, for example. It is thus preferable to (i) sample the voltage value or current value at a time interval of, for example, 10 seconds to 1 minutes and (ii) calculate the difference between those samples.

The detection system described here includes detection electrodes that utilize the derivative value being substantially zero in the steady state. For instance, disposing detection electrodes at a position that is closer to the supply opening for an electrolytic solution than the electrolysis electrodes are to the supply opening maintains the voltage-current relationship based on the electrical properties of the electrolytic solution. In a case where, for instance, the supply of an electrolytic solution has stopped abnormally, detection electrodes disposed at a position in the electrolyzing section which position is close to the supply opening for an electrolytic solution causes the current voltage-current relationship to become closer to the voltage-current relationship of electrical properties of electrolyzed water resulting from the electrolytic solution being electrolyzed with use of the electrolysis electrodes. During this process, the derivative value becomes non-zero. This allows the abnormality to be detected. In a case where detection electrodes are disposed at a position that is even closer to the tank of an electrolytic solution than the electrolyzing section is to the tank, for instance, in a case where detection electrodes are disposed in the pipe or between pipes, an electrolytic solution in the vicinity of the detection electrodes becomes electrolyzed with the detection electrodes, and the derivative value becomes non-zero similarly. This allows the abnormality to be detected.

Disposing detection electrodes at a position that is closer to the discharge opening for an electrolytic solution than the electrolysis electrodes are to the discharge opening maintains the voltage-current relationship based on the electrical properties of the electrolyzed water. In a case where, for instance, the supply of an electrolytic solution has stopped abnormally, detection electrodes disposed at a position in the electrolyzing section which position is close to the discharge opening for an electrolytic solution causes the current voltage-current relationship to become closer to the voltage-current relationship of electricity of electrolyzed water resulting from the electrolytic solution being excessively electrolyzed with use of the electrolysis electrodes. During this process, the derivative value becomes non-zero. This allows the abnormality to be detected. In a case where detection electrodes are disposed at a position that is even closer to the discharge opening for electrolyzed water than the electrolyzing section is to the tank, for instance, in a case where detection electrodes are disposed in the pipe or on the pipe, electrolyzed water in the vicinity of the detection electrodes becomes absent or further electrolyzed with the detection electrodes, and the derivative value becomes non-zero similarly. This allows the abnormality to be detected.

Disposing detection electrodes at a position that is closer to the electrolysis electrodes maintains the voltage-current relationship based on the electrical properties of the electrolytic solution being electrolyzed. In a case where, for instance, the supply of an electrolytic solution has stopped abnormally, detection electrodes disposed at a position that is closer to the electrolysis electrodes causes the current voltage-current relationship to become closer to the voltage-current relationship of electricity of electrolyzed water resulting from the electrolytic solution being excessively electrolyzed with use of the electrolysis electrodes. During this process, the derivative value becomes non-zero. This allows the abnormality to be detected.

In a case where detection electrodes are disposed in the electrolyzing section, part or all of the detection electrodes may double as an electrolysis electrode, and a power source for electrolysis may also be used as a power source for detection.

Detection electrodes are separate from the electrolysis electrodes, and another example includes those detection electrodes as the detecting section. The detection electrodes are disposed above the electrolysis electrodes. In a case where the supply of an electrolytic solution has stopped or become insufficient, the above configuration makes it possible to detect a change in, for example, electrical conductivity in the vicinity of the detection electrodes. Specifically, the detection electrodes are used to detect a decrease in the current value which decrease has been caused by a lowered level of the electrolytic solution in the electrolyzing section. Although the detection section may include a pair of electrodes for the detection, using one of the electrolysis electrodes for both the electrolysis and the detection reduces the parts count. Further using the power source section for both the electrolysis and the detection makes it possible to omit a power source for the detecting section. A lowered level of the electrolytic solution influences the electrolysis electrodes as well; it decreases the current value or increases the voltage value as a result of a reduced effective area of the electrodes. However, the proportion of such a change (that is, the proportion of the change value to the total value), the S/N value, and the like are small. This causes a problem similar to those with conventional art. An abnormality can be detected by, for instance, slitting an upper portion of an electrolysis electrode(s) for a partial separation, connecting a wire to the separated part, and measuring the value of the electric current flowing through the wire. The current value may be measured by any of various conventional methods such as a method of measuring the voltage of a shunt resistor.

Still another example of the detecting section includes detection electrodes as a detector similarly to the above, the detection electrodes being disposed at a position that is closer to the supply opening (that is, the electrolytic solution supply opening of the electrolyzing section) for an electrolytic substance (electrolytic solution) than the electrolysis electrodes are to the supply opening. Using the above detection electrodes to detect a difference between electrical properties of the electrolytic substance and those of an electrolysis product (electrolyzed water) makes it possible to detect whether the supply of the electrolytic substance (electrolytic solution) has stopped or become insufficient. The steady state leads the detecting section to obtain values relatively close to those of the electrical properties of the electrolytic substance (electrolytic solution), whereas an abnormal state leads the detecting section to obtain values relatively close to those of the electrical properties of the electrolysis product (electrolyzed water). This allows an abnormality to be detected.

Still another example of the detecting section includes detection electrodes as a detector similarly to the above, the detection electrodes being disposed (i) at a position (that is, the discharge opening of the electrolyzing section 5 for the case of electrolysis) that is closer to the discharge opening for an electrolysis product than the electrolysis electrodes are to the discharge opening, (ii) at the discharge opening, (iii) on a pipe connected to the discharge opening, or (iv) between pipes.

Using the above detection electrodes to detect a difference in electrical properties between the normal state (in which an electrolysis product [electrolyzed water] is being flown to the detector continuously) and not the normal state (in which electrolyzed water is not being flown to the detector continuously) makes it possible to detect whether the supply of the electrolytic substance (electrolytic solution) has stopped. The above configuration also makes it possible to detect, for example, the following abnormality: Although an electrolytic solution is being flown to the detecting section, a failure such as a breakage of the electrolyzing section causes the amount of electrolyzed water discharged from the electrolyzing section to be smaller than normal or even stops the discharge altogether.

Detecting a difference in electrical properties between the normal state (in which an electrolysis product [electrolyzed water] is being flown to the detector continuously) and a state in which an electrolytic substance (electrolytic solution) is being flown to the detector continuously) makes it possible to detect, for example, the following abnormality: Although an electrolytic substance (electrolytic solution) is being supplied normally, the electrolytic substance is electrolyzed insufficiently or is not electrolyzed.

The detection electrodes may at least partially double as an electrode for electrolysis. This configuration is preferable because it reduces the parts count and cost for increased practicability. Including an inclined detection electrode pair is preferable because it increases the detectability. The electrolyzing section may preferably further include a cooling system, in particular a water-cooling system.

In a case where a detection electrode pair and an electrolysis electrode pair are to be included in the electrolyzing section in such a manner as to be parallel to each other, a holding section for holding the detection electrode pair and the electrolysis electrode pair may be formed to also serve as the electrolyzing section. This can reduce costs. It is preferable to further incline an electrolyzing section including a detection electrode pair and an electrolysis electrode pair that are parallel to each other. This increases both the detectability and electrolysis efficiency. Further including a water-cooling system stabilizes the respective temperatures of the detection electrodes and the electrolysis electrodes, and thereby provides a highly reliable detection system and electrolysis system. This is because the electrical properties and chemical reactions of a substance are typically temperature-dependent. Since a detector including electrodes utilizes electrical properties of a substance, and electrolysis utilizes an electrochemical reaction, a stable temperature is preferable, and including a cooling system is preferable.

The diluting section 18 serves to dilute, with water, electrolyzed water produced by the electrolyzing section 5. This configuration makes it possible to produce electrolyzed water having an appropriate effective chlorine concentration and to discharge such electrolyzed water from the discharge opening 29.

Including the diluting section 18 to dilute electrolyzed water produced by the electrolyzing section 5 makes it possible to increase the amount of electrolyzed water produced. The water for the dilution is, for example, tap water, well water, or stored water. In a case where the diluting section 18 dilutes electrolyzed water with tap water, a valve 16 may be connected to a faucet for supply of tap water to the diluting section 18. In a case where the diluting section 18 dilutes electrolyzed water with well water and/or stored water, a pump for drawing up well water or stored water may be used for supply of well water or stored water to the diluting section 18. The electrolytic solution may alternatively be diluted before being electrolyzed. In this case, however, a mineral and/or the like contained in dilution water may be deposited on the electrolysis electrodes to decrease the electrolysis capability, or a component contained in dilution water may be electrolyzed to cause variations in the concentration, pH, and/or the like of the electrolyzed water. It is thus preferable to first electrolyze the electrolytic solution at the electrolyzing section and then dilute the electrolyzed water with tap water or the like as in the present embodiment.

The diluting section 18 may be configuration such that electrolyzed water produced by the electrolyzing section 5 and dilution water flow into each other. In this case, the diluting section 18 is configured such that the flow of electrolyzed water produced by the electrolyzing section 5 joins a substantially horizontal flow of water. The diluting section 18 may also be configured such that electrolyzed water produced by the electrolyzing section 5 is attracted to dilution water as a result of the Venturi effect caused by the flow of the dilution water.

The diluting section 18 may be configured to dilute electrolyzed water in a dilution bath configured to receive the flow of electrolyzed water produced by the electrolyzing section 5 and the flow of dilution water. The diluting section 18 may be configured to include a dilution bath in which the electrode pair 1 is disposed. This configuration allows (i) the dilution bath to store a diluted electrolytic solution and (ii) this stored electrolytic solution to be subjected to an electrolytic treatment with use of the electrode pair 1 to produce electrolyzed water.

The electrolyzed water producing apparatus 25 may be configured to be capable of changing the amount of dilution water used by the diluting section 18. The electrolyzed water producing apparatus 25 may, for instance, include a valve 16 or pump to be capable of changing the amount of water to be supplied to the diluting section 18. This configuration makes it possible to produce electrolyzed water having any of different effective chlorine concentrations and to produce electrolyzed water having an effective chlorine concentration customized for the use of the electrolyzed water.

The electrolyzed water producing apparatus 25 may include a control section to enable switching between electrolyzed water having a normal concentration and electrolyzed water having a high concentration. The control section controls the valve 16 or pump to switch concentrations for electrolyzed water. For example, electrolyzed water having a normal concentration may have an effective chlorine concentration within a range of 15 ppm to 25 ppm, and electrolyzed water having a high concentration may have an effective chlorine concentration within a range of 45 ppm to 55 ppm.

It is further preferable to include a needle valve instead of a switch-type electromagnetic valve. A needle valve is capable of changing the flow rate continuously, and thus makes it possible to continuously produce electrolyzed water with any high concentration from electrolyzed water having a minimum concentration at the time of a maximum flow rate.

The electrolyzed water producing apparatus 25 may include a cooling section 34 configured to cool the electrolyzing section 5 with use of water for dilution of electrolyzed water. This configuration makes it possible to prevent the temperature of the electrolyzing section 5 from being increased by (i) heat generated as a result of electric resistance of the electrodes and/or solution resistance of the electrolytic solution and/or (ii) heat of various chemical reactions occurring in the electrolyzing section. The above configuration in turn makes it possible to prevent the concentration from varying as a result of a varying electrolysis efficiency and also prevent the respective lives of, for example, the electrolyzing section and the electrodes from being shortened by heat. The cooling section 34 may, for instance, include a cooling-water channel 33 through which dilution water flows. This configuration is preferable because it makes it possible to form a cooling-water channel together with the electrolyzing section as an integral part thereof and avoid the need for extra parts or attachment operation.

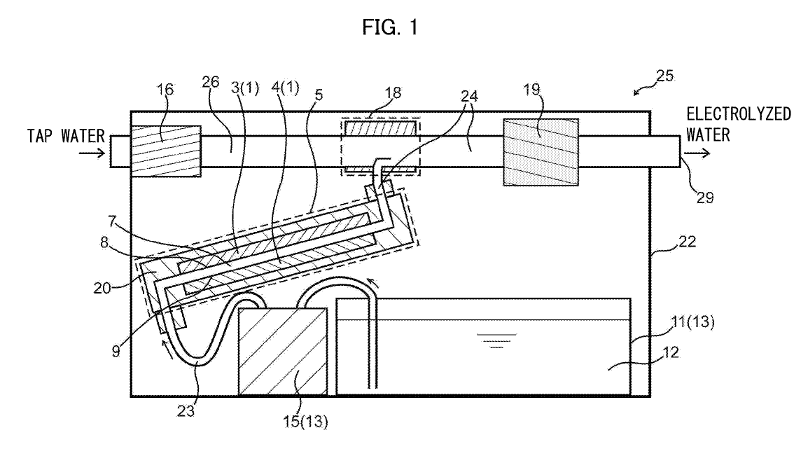

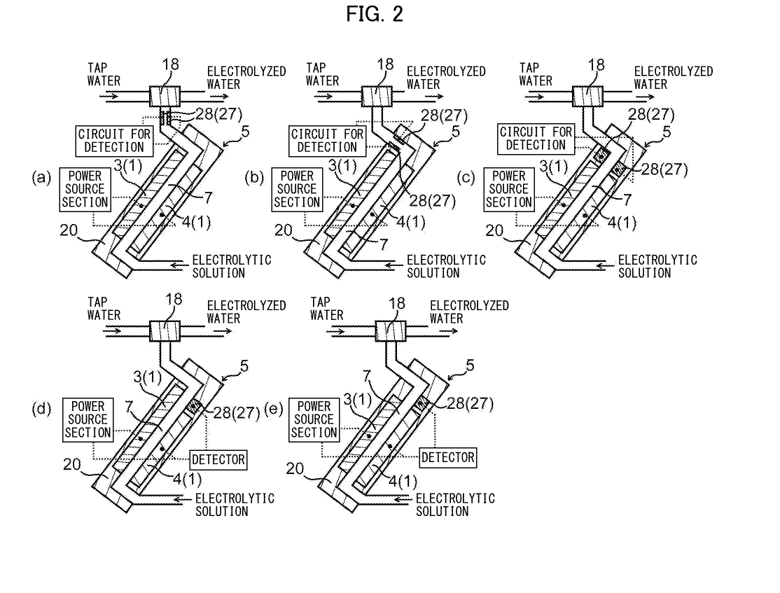

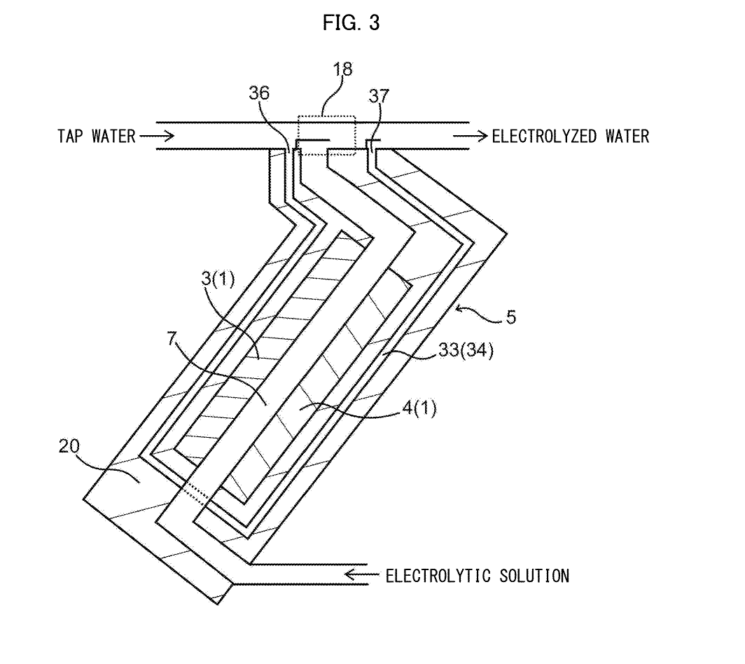

FIG. 3 is a schematic cross-sectional view of part of an electrolyzed water producing apparatus 25 of Embodiment 7. The cooling-water channel 33 may be configured, for example, such that as in Embodiment 7 illustrated in FIG. 3, tap water flows into the cooling-water channel 33 from a cooling-water inlet 36 positioned upstream of the diluting section 18, flows around the electrode pair 1, and then flows out from a cooling-water outlet 37 positioned downstream of the diluting section 18. Forming a cooling-water channel 33 as described above makes it possible to use tap water for the dilution of electrolyzed water to also cool the electrolyzing section 5.

The cooling-water channel 33 may be formed in the structural member 20 of the electrolyzing section 5 as illustrated in FIG. 3, or may be in the form of a pipe disposed around the electrolyzing section 5.

The electrolyzed water producing apparatus 25 may include a stirring section 19. The stirring section 19 is configured to receive the flow of electrolyzed water diluted by the diluting section 18 and cause the electrolyzed water to flow out toward the discharge opening 29. Including such a stirring section 19 makes it possible to convert, into hypochlorous acids, chlorine gas that has not been converted by the electrolyzing section 5 or the diluting section 18 into hypochlorous acids. This in turn stabilizes, for example, the pH and effective chlorine concentration of electrolyzed water discharged from the discharge opening 29, thereby making it possible to produce electrolyzed water having a stable quality. The stirring section 19 may be a water tank in which a turbulent flow occurs or a stirring tank including a stirrer.

### Effective Chlorine Concentration Measuring Experiment

An electrolyzing device was prepared that was similar to the electrolyzing section 5 of the electrolyzed water producing apparatus 25 illustrated in FIG. 1. An electrolysis experiment was conducted while the angle at which the electrode pair 1 was inclined relative to the vertical direction was changed. The electrode pair 1 included (i) an electrode (herein referred to as Ti electrode) made of a titanium plate with a long side of 8 cm, a short side of 3 cm, and a thickness of 1 mm and (ii) an electrode (herein referred to as Pt—Ir-coated Ti electrode) prepared by coating a titanium plate with a long side of 8 cm, a short side of 3 cm, and a thickness of 1 mm with platinum and iridium through a sintering process. The electrode pair 1 was fixed to a structural member 20 made of vinyl chloride resin in such a manner that the Ti electrode and the Pt—Ir-coated Ti electrode were substantially parallel to each other and separated from each other by a distance within a range of 1 mm to 5 mm. This prepared an electrolyzing device. The electrode pair 1 was connected to a power source device in such a manner that the Ti electrode would serve as a negative electrode and that the Pt—Ir-coated Ti electrode would serve as a positive electrode.

An electrolyzing device was installed while the angle at which the electrode pair 1 was inclined relative to the vertical direction was changed between approximately −80 degrees to approximately +80 degrees. A mixed aqueous solution of 2% to 4% sodium chloride and 0.3% to 0.4% hydrochloric acid was supplied to the electrode electrolytic solution channel 7 from below at a fixed flow rate. The angle of inclination was (i) 0 degrees in a case where the electrode pair 1 extended vertically, (ii) a positive value in degree in a case where the electrode pair 1 was inclined in such a manner that the Pt—Ir-coated Ti electrode (positive electrode) was positioned higher, and (iii) a negative value in degree in a case where the electrode pair 1 was inclined in such a manner that the Pt—Ir-coated Ti electrode was positioned lower.

The power source device was operated to supply a constant current of 5 A to the electrode pair 1 for an electrolytic treatment of a mixed aqueous solution of sodium chloride and hydrochloric acid. The voltage applied was within a range of approximately 4 V to 5 V. The effective chlorine concentration (mg/L) of the aqueous solution after the electrolytic treatment was measured. The effective chlorine concentration was evaluated on the basis of color reaction caused by oxidation. The effective chlorine concentration of this Example thus shows a value indicative of the amount of all oxidative reactive substances.

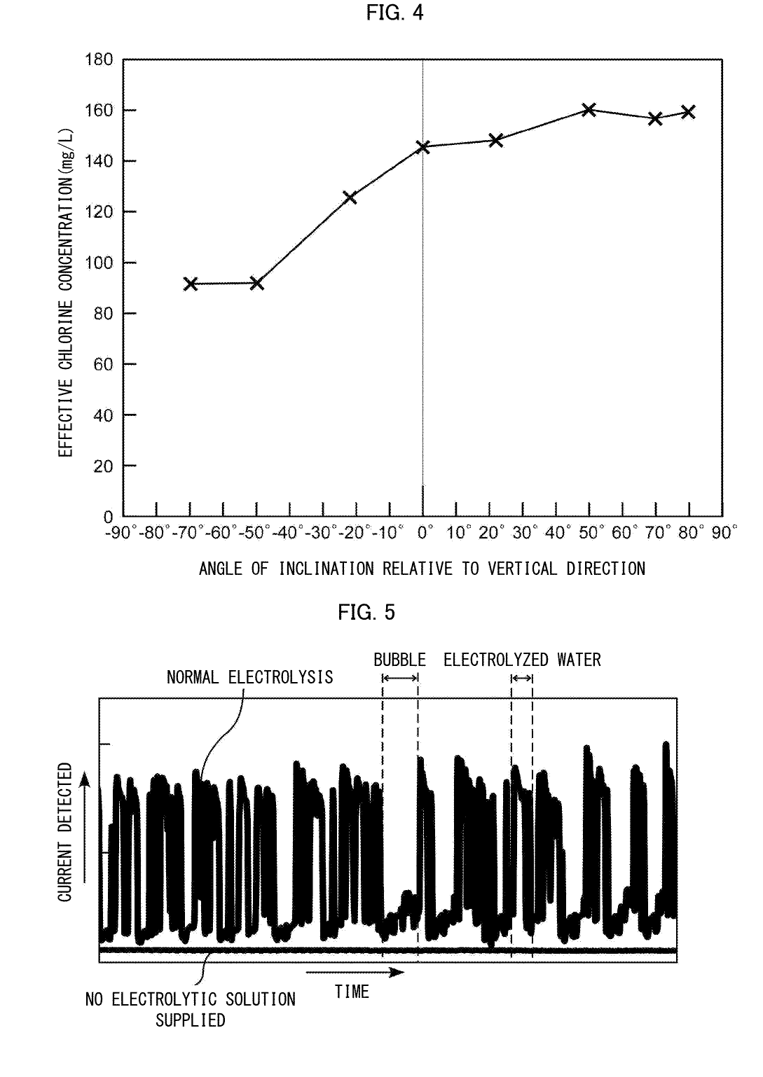

FIG. 4 shows the measurement results of the experiment on the effective chlorine concentration. The effective chlorine concentration shown in FIG. 4 is for a case in which electrolyzed water was diluted with 1 L of water by normalization. The results show that inclining the electrode pair 1 in such a manner that the Pt—Ir-coated Ti electrode (positive electrode) was positioned higher successfully increased the effective chlorine concentration of an aqueous solution after an electrolytic treatment within a range of the inclination angle of 20 degrees to 80 degrees. The effective chlorine concentration was particularly high within a range of 50 degrees to 80 degrees. Although the effective chlorine concentration was high with an inclination angle of 85 degrees (not shown in FIG. 4), the effective chlorine concentration tended to vary greatly with an inclination angle of 85 degrees, for example, the effective chlorine concentration decreased occasionally.

The results also show that inclining the electrode pair in such a manner that the Pt—Ir-coated Ti electrode (positive electrode) was positioned lower decreased the effective chlorine concentration of an aqueous solution after an electrolytic treatment.

This proves that inclining the electrode pair 1 in such a manner that the positive electrode is positioned higher than the negative electrode increases the effective chlorine concentration of electrolyzed water produced.

FIG. 4 shows that (i) the effective chlorine concentration generally increased gently on the positive angle side of 0 degrees and substantially leveled off at 50 degrees and above and that (ii) the effective chlorine concentration dropped sharply on the negative angle side of 0 degrees and substantially leveled off at −50 degrees and below. This indicates that it is preferable to incline the electrode pair not less than 0 degrees in such a manner that the positive electrode is positioned higher. It is, however, preferable to install the producing apparatus including the electrode pair in such a manner that the producing apparatus is inclined not less than 10 degrees as a precaution to allow for approximately 10 degrees as an error. This prevents produced electrolyzed water from having an effective chlorine concentration decreased as a result of (i) insufficient accuracy of attaching the electrode pair or (ii) attaching the producing apparatus on, for example, a slightly inclined ground. If the producing apparatus is inclined 80 degrees, on the other hand, an additional inclination of 10 degrees will result in an inclination angle of 90 degrees. It is thus preferable to incline the producing apparatus up to 75 degrees. It is therefore preferable to incline the producing apparatus 10 degrees to 75 degrees. In a case where the producing apparatus may be used on, for example, an outdoor, sloping ground, the producing apparatus may be inclined approximately 50 degrees. In this case, an additional inclination of ±30 degrees will still allow the producing apparatus to produce electrolyzed water having an effective chlorine concentration higher than in a case where the producing apparatus is inclined 0 degrees. This configuration particularly conveniently makes it possible to avoid the need to make certain that the electrolyzed water producing apparatus is placed horizontally in a case where the electrolyzed water producing apparatus is used to spray water on plants or eliminate bacteria from soil on a sloping ground having a steep slope of 30 degrees, for example, on a mandarin orange field or vineyard. In the case where the electrolyzed water producing apparatus is used for plants as such, it is preferable to use an aqueous potassium chloride solution, hydrochloric acid, or a mixture thereof as the electrolytic solution.

### Electrolyzed Water Detecting Experiment

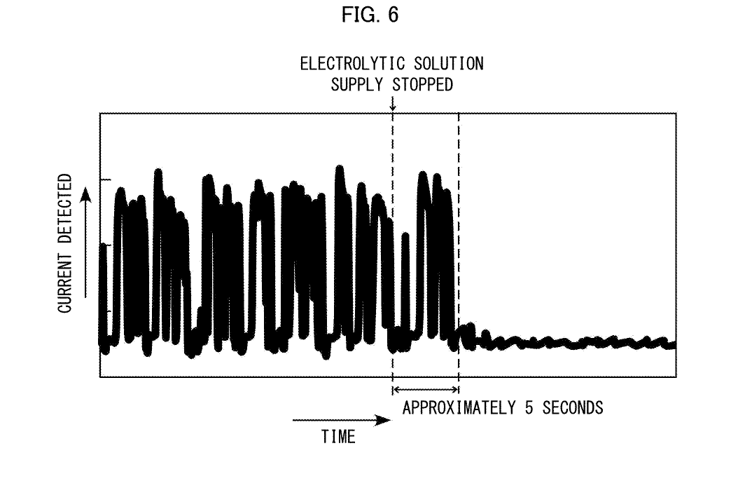

An electrolyzing section 5 similar to that illustrated in (c) of FIG. 2 was prepared. An experiment was conducted for detecting, with use of detection electrodes 28, electrolyzed water produced with use of an electrode pair 1. With the direction perpendicular to the surface of (c) of FIG. 2 as corresponding to the width of each channel, that portion of the channel at which portion electrolysis electrodes were disposed had a width of approximately 50 mm, which was substantially equal to the width of an electrolysis electrode, whereas that portion of the channel at which detection electrodes were disposed had a relatively small width of approximately 3 mm. This is because since this Example had a basic principle of detecting gas and liquid as described later, failing to form such a relatively narrow channel will (i) let gas and liquid be separated from each other or (ii) make it difficult to detect gas and liquid as a result of an excessively small gap between the gas and the liquid. The detection electrodes had an effective area of 3 mm by 3 mm, and were separated from each other by a distance of 2 mm. The detection electrodes were made of the same material as that of which the electrolysis electrodes were made. FIGS. 5 and 6 show the results of the experiment.

FIG. 5 is a graph illustrating how the current detected by the detection electrodes 28 changed when an electrolytic solution 12 was supplied to the electrolyzing section 5 and electrolyzed with use of the electrode pair 1 for production of electrolyzed water. The graph shows that (i) while electrolyzed water was being produced normally, the current detected by the detection electrodes 28 fluctuated and that (ii) the current detected may be small for a time period of not more than 5 seconds. This is presumably due to alternate passage by the detection electrodes 28 of (i) bubbles of chlorine gas and/or hydrogen gas generated as a result of electrolysis and (ii) electrolyzed water. The experimental results thus show that (i) detecting whether the current being detected fluctuates as above makes it possible to detect whether electrolyzed water is being produced normally and that (ii) detecting a small current continuously for not less than 5 seconds indicates no supply of an electrolytic solution 12 to the electrolyzing section 5.

FIG. 6 is a graph illustrating how the current detected by the detection electrodes 28 changed when the supply of an electrolytic solution 12 to the electrolyzing section 5 stopped. When the supply of an electrolytic solution 12 stopped, the fluctuation of the detected current stopped being measured approximately 5 seconds after the stop of the supply. This shows that using the detection electrodes 28 makes it possible to detect a stop of the supply of an electrolytic solution 12 earlier.

The producing apparatus may be structured as illustrated in (a) of FIG. 2 to include detection electrodes in a pipe disposed between an electrolytic bath and a discharge opening. An experiment was conducted with a pipe having an inner diameter of approximately 3 mm. The results of this experiment were similar to those described above.

### REFERENCE SIGNS LIST

1 Electrode pair

3 Positive electrode

4 Negative electrode

5 Electrolyzing section

7 Electrolytic solution channel

8 Electrode surface of positive electrode

9 Electrode surface of negative electrode

11 Tank

12 Electrolytic solution

13 Electrolytic solution supplying section

15 Pump

16 Valve

18 Diluting section

19 Stirring section

20 Structural member

22 Housing

23 Supply channel

24 Electrolyzed water channel

25 Electrolyzed water producing apparatus

26 Tap water channel

27 Detecting section

28 Detection electrode

29 Discharge opening

33 Cooling water channel

34 Cooling section

36 Cooling-water inlet

37 Cooling-water outlet

1. An electrolyzed water producing apparatus, comprising:
an electrolyzing section,
the electrolyzing section including (i) an electrode pair having a positive electrode and a negative electrode facing the positive electrode and (ii) a no-diaphragm-type electrolytic solution channel between the positive electrode and the negative electrode,
the electrode pair being inclined in such a manner that the positive electrode is positioned higher than the negative electrode,
the electrolytic solution channel allowing an electrolytic solution to flow into the electrolytic solution channel from below and allowing electrolyzed water, which has been produced by electrolyzing the electrolytic solution with use of the electrode pair and which contains hypochlorous acids, to flow out from an upper portion of the electrolytic solution channel,
the electrode pair being inclined at an angle of not less than 10 degrees and not more than 85 degrees relative to a vertical direction.

2. The electrolyzed water producing apparatus according to claim 1,
wherein
the electrode pair is inclined at an angle of not less than 50 degrees and not more than 80 degrees relative to the vertical direction.

3. The electrolyzed water producing apparatus according to claim 1,
wherein
the positive electrode and the negative electrode each have a substantially rectangular electrode surface and are each oriented in such a manner that a first lengthwise end of the electrode surface is positioned higher than a second lengthwise end of the electrode surface.

4. The electrolyzed water producing apparatus according to claim 3,
wherein
the electrode pair is configured such that a ratio of (i) a distance between the positive electrode and the negative electrode to (ii) a length of the electrode surface is within a range of 1:100 to 1:10.

5. The electrolyzed water producing apparatus according to claim 1,
wherein
the negative electrode is a Ti electrode.

6. The electrolyzed water producing apparatus according to claim 1,
wherein
the electrolytic solution includes an aqueous solution containing an acidic substance and an alkali metal chloride.

7. The electrolyzed water producing apparatus according to claim 1, further comprising:
a diluting section configured to dilute the electrolyzed rater, which is produced by the electrolyzing section.

8. The electrolyzed water producing apparatus according to claim 7, further comprising:
a cooling section configured to cool the electrode pair,
wherein
the cooling section cools the electrode pair with use of water intended for dilution of the electrolyzed water.

9. The electrolyzed water producing apparatus according to claim 1, further comprising:
an electrolytic solution supplying section; and
a detecting section,
wherein
the detecting section includes a detection electrode for measuring an electrical property of the electrolytic solution, the electrolyzed water, or a mixture of the electrolytic solution and the electrolyzed water and is configured to detect (i) a decrease in an amount of the electrolytic solution which amount is supplied to the electrolyzing section or (ii) a decrease in an amount of the electrolyzed water which amount is discharged from the electrolyzing section.

10. The electrolyzed water producing apparatus according to claim 1, further comprising:
an electrolytic solution supplying section; and
a detecting section,
wherein
the detecting section is configured to, on a basis of an amount of change over time in a relationship between a current flowing through the electrode pair and a voltage applied to the electrode pair, detect a decrease in an amount of the electrolytic solution which amount is supplied to the electrolyzing section.
